(19) United States
(12) Patent Application Publication
(10) Pub. No.: US 2017/0111132 A1
(43) Pub. Date: Apr. 20, 2017

(54) METHOD AND APPARATUS FOR BROADCASTING VEHICLE MESSAGE

(71) Applicant: SAMSUNG ELECTRONICS CO., LTD., Suwon-si (KR)

(72) Inventors: Jaewook SHIM, Yongin-si (KR); Tae Seok KIM, Hwaseong-si (KR); Seungkeun YOON, Seoul (KR)

(73) Assignee: SAMSUNG ELECTRONICS CO., LTD., Suwon-si (KR)

(21) Appl. No.: 15/272,944

(22) Filed: Sep. 22, 2016

(30) Foreign Application Priority Data
Oct. 16, 2015 (KR) 10-2015-0144518

(51) Int. Cl. H04H 20/16; H04W 4/00; H04W 52/22

(52) U.S. Cl. CPC H04H 20/16; H04W 52/223; H04W 4/008; H04W 84/12

(57) ABSTRACT

A vehicle message broadcasting method includes determining whether a transmission power set for broadcasting a message by a communication device using a first wireless communication scheme is to be adjusted, the first wireless communication scheme being used to transmit a safety message (SM), broadcasting a safety message (SM) using the first wireless communication scheme with a transmission power based on a result of the determining, broadcasting at least one additional message including information included in the SM and/or information related to the SM using a second wireless communication scheme having a wider coverage than a coverage of the first wireless communication scheme.

### CROSS-REFERENCE TO RELATED APPLICATION

This application claims the benefit under 35 USC 119(a) of Korean Patent Application No. 10-2015-0144518, filed on Oct. 16, 2015, in the Korean Intellectual Property Office, the entire disclosure of which is incorporated herein by reference for all purposes.

### BACKGROUND

1. Field

The following description relates to a method and apparatus for broadcasting a vehicle message. More particularly, the following description relates to a method and apparatus for broadcasting a vehicle message using wireless communication schemes.

2. Description of Related Art

Due to advances in various sensing technologies, technology for sensing a state of a vehicle and using sensed information related to the vehicle has been developed. In particular, a technology associated with a vehicular communication network has been developed. The vehicular communication network may be used to transmit information of a vehicle to another vehicle to assist driving of the vehicle.

The vehicular communication network may be divided into an in-vehicle network (IVN) and an out-vehicle network. The IVN refers to a wired or wireless communication network between sensors or electronic devices in a vehicle. The out-vehicle network may be further divided into a vehicle-to-infrastructure (V2I) network and a vehicle-to-vehicle (V2V) network. The V2I network is a vehicular communication infrastructure technology including communication between a vehicle and a road side unit (RSU) or other non-vehicle communication devices. For example, the vehicle may receive traffic information and safety support services from the RSU through the V2I. The V2V network is an autonomous vehicle network technology including wireless communication between vehicles. For example, a driver may receive messages that enables safer driving from neighboring vehicles through the V2V, e.g., to prevent traffic accidents. Thus, the V2V is a communication network that may be associated with safety of a driver, and there is a desire for reliability and real-time performance for the V2V.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A vehicle message broadcasting method includes determining whether a transmission power set for broadcasting a message by a communication device using a first wireless communication scheme is to be adjusted, the first wireless communication scheme being used to transmit a safety message (SM), broadcasting a safety message (SM) using the first wireless communication scheme with a transmission power based on a result of the determining, broadcasting at least one additional message including information included in the SM and/or information related to the SM using a second wireless communication scheme having a wider coverage than a coverage of the first wireless communication scheme.

The first wireless communication scheme may be a dedicated short-range communications (DSRC) scheme based on an Institute of Electrical and Electronics Engineers (IEEE) 802.11p standard.

The first wireless communication scheme may be a wireless communication scheme based on an IEEE 802.11p standard, and the second wireless communication scheme is a cellular communication scheme.

The first wireless communication scheme and the second wireless communication scheme may be wireless communication schemes based on an IEEE 802.11p standard, and a frequency channel of the first wireless communication scheme may be different than a frequency channel of the second wireless communication scheme.

The at least one additional message may include an additional message that includes same information as information included in as the SM.

The at least one additional message may include an event message (EM) generated in response to an event related to a vehicle and related to the SM.

The EM may include location information corresponding to a location of the event.

The vehicle message broadcasting method may further include generating the SM, wherein the generating of the SM includes acquiring information related to a vehicle, and generating the SM based on the information related to the vehicle.

The generating of the SM may further include detecting an event related to the vehicle, and, may further include information about the event to the SM and generating the SM in response to the event being detected.

The vehicle message broadcasting method may further include generating the additional message, wherein the generating of the additional message includes detecting an event occurring in the vehicle and generating the additional message based on the detected event.

The determining of whether the transmission power may include calculating a transmission success rate of the SM transmitted using the first wireless communication scheme; and determining to adjust the transmission power lower in response to the transmission success rate being determined to be less than a threshold success rate.

The determining of whether the transmission power is to be adjusted may include determining to adjust the transmission power based on determined properties of at least one externally received SM.

The determining to adjust the transmission power based on the at least one external SM may include, in response to a number of the neighboring vehicles identified by the plurality of external SMs is determined to be equal to or greater than a preset threshold, determining to adjust the transmission power lower.

The vehicle message broadcasting method may further include receiving a guide from a road side unit (RSU), and the determining of whether the transmission power is to be adjusted may include determining, based on the guide, whether the transmission power is to be adjusted.

A vehicle message broadcasting apparatus includes a processor configured to determine whether a transmission power of a first wireless communication scheme is to be adjusted, the first wireless communication scheme being used to transmit a safety message (SM), and a communicator configured to broadcast the SM using the first wireless communication scheme with the adjusted transmission power and to broadcast at least one additional message using a second wireless communication scheme.

A vehicle message receiving method includes receiving a safety message (SM) comprising information related to a vehicle using a first wireless communication scheme, receiving an additional message including information included in or related to the SM using a second wireless communication scheme having a different property from the first wireless communication scheme, and outputting information included in at least one of the SM and the additional message.

The first wireless communication scheme may be a dedicated short-range communications (DSRC) scheme based on an Institute of Electrical and Electronics Engineers (IEEE) 802.11p standard.

The first wireless communication scheme may be a wireless communication scheme based on an IEEE 802.11p standard, and the second wireless communication scheme may be a cellular communication scheme.

The first wireless communication scheme and the second wireless communication scheme may be wireless communication schemes based on an IEEE 802.11p standard, and wherein a frequency channel of the first wireless communication scheme may be different from a frequency channel of the second wireless communication scheme.

The receiving of the additional message may include receiving the additional message from a road side unit (RSU).

The RSU may broadcast the additional message based on location information of an event, and the location information of the event may be included in the additional message.

A vehicle message receiving apparatus includes a communicator configured to receive a safety message (SM) using a first wireless communication scheme and to receive an additional message using a second wireless communication scheme with a different property than a first wireless communication scheme and a processor configured to output information included in at least one of the SM and the additional message.

Other features and aspects will be apparent from the following detailed description, the drawings, and the claims.

### BRIEF DESCRIPTION OF THE DRAWINGS

FIG. 1 illustrates broadcasting a safety message (SM) in accordance with an embodiment.

FIG. 2 illustrates a configuration of a vehicle message broadcasting apparatus in accordance with an embodiment.

FIG. 3 illustrates a vehicle message broadcasting method in accordance with an embodiment.

FIG. 4 illustrates a coverage of a wireless communication scheme of which a transmission power is adjusted in accordance with an embodiment.

FIG. 5 illustrates a broadcasting of an additional message in accordance with an embodiment.

FIG. 6 illustrates a broadcasting of an additional message in accordance with an embodiment.

FIG. 7 illustrates a generating of an SM in a vehicle message broadcasting method in accordance with an embodiment.

FIG. 8 illustrates a generating of an additional message in accordance with an embodiment.

FIG. 9 illustrates a determining of whether a transmission power is to be adjusted in a vehicle message broadcasting method in accordance with an embodiment.

FIG. 10 illustrates determining whether a transmission power is to be adjusted in a vehicle message broadcasting method in accordance with an embodiment.

FIG. 11 illustrates determining whether a transmission power is to be adjusted in a vehicle message broadcasting method in accordance with an embodiment.

FIG. 12 illustrates a configuration of a vehicle message receiving apparatus in accordance with an embodiment.

FIG. 13 illustrates a vehicle message receiving method in accordance with an embodiment.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art after a full understanding of the present disclosure. The sequences of operations described herein are merely examples, and are not limited to those set forth herein, but may be changed as will be apparent to one of ordinary skill in the art, having a full understanding of the present specification, with the exception of operations necessarily occurring in a certain order. Also, descriptions of functions and constructions that are well known to one of ordinary skill in the art after having a full understanding of the present specification may be omitted for increased clarity and conciseness.

The features described herein may be embodied in different forms, and are not to be construed as being limited to the examples described herein. Rather, the examples described herein have been provided so that this disclosure will be thorough and complete, and will convey a scope of the disclosure to one of ordinary skill in the art.

Various alterations and modifications may be made to the examples. Here, the examples are not construed as limited to the disclosure and should be understood to include all changes, equivalents, and replacements within the idea and the technical scope of the disclosure.

The terminology used herein is for the purpose of describing particular examples only and is not to be limiting of the examples nor to exclude alternatives. A singular expression includes a plural expression except when two expressions are contextually different from each other. For example, as used herein, the singular forms “a”, “an”, and “the” are intended to include the plural forms as well, unless the context clearly indicates otherwise. It will be further understood that the terms “include/comprise” and/or “have” when used in this specification, specify the presence of stated features, integers, operations, elements, components, and/or combinations thereof, but do not preclude the presence or addition of one or more other features, numbers, operations, elements, components, and/or groups thereof.

Unless otherwise defined, all terms including technical and scientific terms used herein have the same meaning as commonly understood by one of ordinary skill in the art to which examples belong. It will be further understood that such terms, including those defined in commonly-used dictionaries, should be interpreted as having a meaning that is consistent with their meaning in the context of the relevant art and the present disclosure and will not be interpreted in an idealized or overly formal sense unless expressly so defined herein.

When describing the examples with reference to the accompanying drawings, like reference numerals refer to like constituent elements and a repeated description related thereto will be omitted. When it is determined discussions related to a related known operation or configuration that may make the purpose of the examples unnecessarily ambiguous in describing the examples, such discussions in the detailed description will be omitted here.

Hereinafter, reference will now be made in detail to examples with reference to the accompanying drawings, wherein like reference numerals refer to like elements throughout.

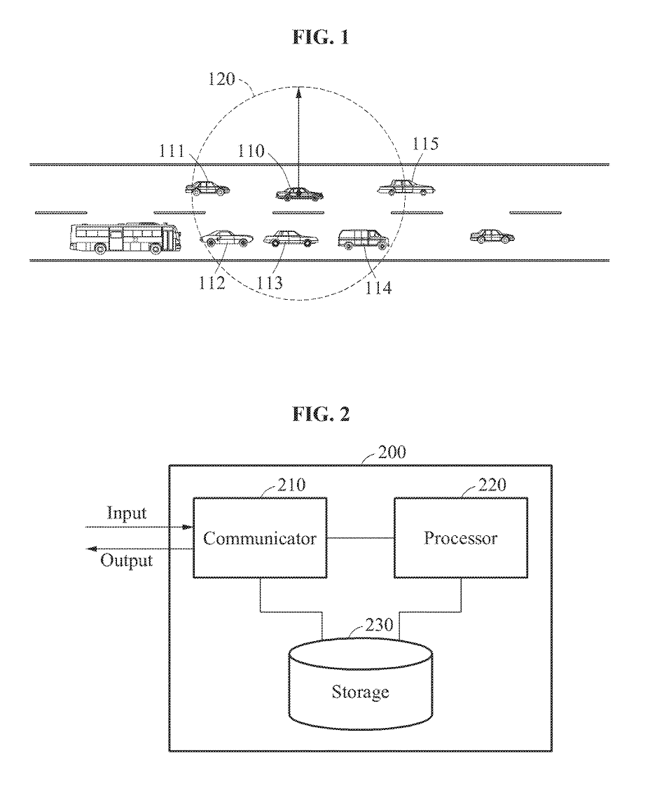

FIG. 1 illustrates broadcasting a safety message (SM) in accordance with an embodiment.

A vehicle 110 reports a state of the vehicle 110 to neighboring vehicles 111, 112, 113, 114 and 115 located adjacent to the vehicle 110. For example, the vehicle 110 may broadcast a message including information about the state of the vehicle 110 to the neighboring vehicles 111 through 115. The neighboring vehicles 111 through 115 may receive the message from the vehicle 110, and may adjust their operation based on the state of the vehicle 110. Vehicles may transmit and receive messages using a vehicle communication technology, for example, a vehicle-to-vehicle (V2V) network.

The neighboring vehicles 111 through 115 receiving the message from the vehicle 110 are located in an exemplary range 120, e.g., defined by radius around the vehicle 110. The range 120 is, for example, a coverage of a wireless communication scheme to broadcast a message.

The vehicle 110 may broadcast a message using a wireless communication scheme. Depending on embodiment, the wireless communication scheme may use or operate in accordance with an Institute of Electrical and Electronics Engineers (IEEE) 802.11p standard, such as a dedicated short-range communications (DSRC) scheme or other conforming scheme, and/or an IEEE 1609.x standard for wireless access in vehicular environments (WAVE), noting that alternative communication schemes are also available. For example, a wireless communication scheme based on the IEEE 802.11p and the IEEE 1609.x for WAVE may be referred to as a DSRC or WAVE communication scheme.

All the vehicles 110 through 115 may use the same frequency band or channel to broadcast messages, as only an example. A message from a vehicle failing to acquire a communication channel for any reason, such as an insufficient communication capacity among the vehicles 110 through 115, may not be broadcast. Such a failure may be due to failures to access a network or communication channel by either of broadcasting or intended receiver(s). As such, an emergent or urgent message of the vehicle 110 may not be broadcast to the neighboring vehicles 111 through 115 or may not be broadcast in sufficient time. In this case, if vehicle 110 fails to acquire a communication channel, and the vehicle 110, for example, suddenly stops, a state of the vehicle 110 may not be broadcast to the vehicle 111 in the rear of the vehicle 110.

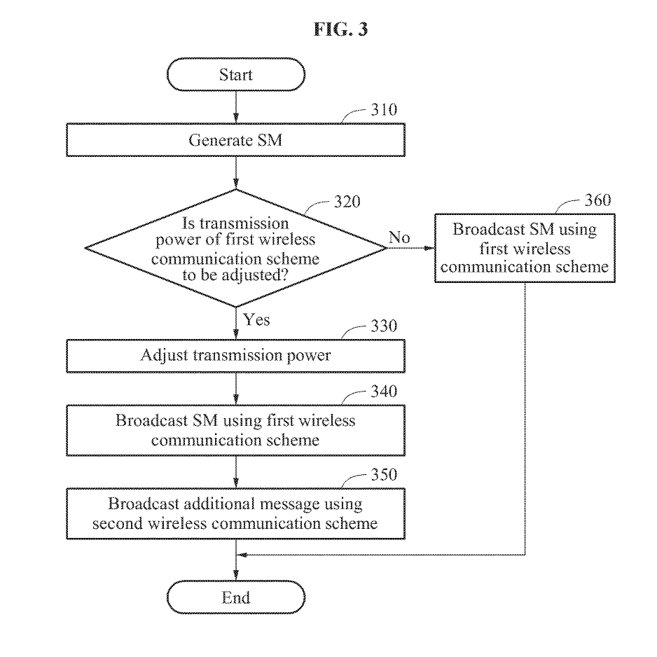

In a case such as the one stated above, real-time message broadcasting may be important. That is, in one or more embodiments, an emergent or urgent message from vehicle 110 should be instantly broadcast to the neighboring vehicles 111 through 115. Hereinafter, through one or more embodiments, methods of transmitting a vehicle message is further described with reference to FIGS. 2, 3, 4, 5, 6, 7, 8, 9, 10 and 11.

FIG. 2 illustrates a configuration of a vehicle message broadcasting apparatus 200 in accordance with an embodiment.

Referring to FIG. 2, the vehicle message broadcasting apparatus 200 (hereinafter, referred to as the “apparatus 200”) includes a communicator 210, a processor 220, and storage 230. The apparatus 200 may be included in, for example, the vehicle 110 of FIG. 1, or the apparatus 200 may be the example vehicle 110 of FIG. 1, for example.

The communicator 210 is communication hardware configured to exchange data and/or information with an external apparatus. The communicator 210 may be wirelessly connected to differing components or apparatuses of a vehicle in which the apparatus 200 is installed. For example, the apparatus 200 may be included in an on-board unit (OBU) or an on-board equipment (OBE) of the vehicle.

The processor 220 may be, for example, a hardware processing device or processor. The processor 220 may process data received by the communicator 210 and data stored in the storage 230.

The storage 230 may store data received by the communicator 210 and data processed by the processor 220.

Hereinafter, example operations of such a communicator, the processor and storage are further described with reference to FIGS. 3 through 11. For convenience, below operations of FIGS. 3-11 will be discussed with reference to the example communicator 210, processor 220, and storage 230, noting that alternatives are available.

FIG. 3 illustrates a vehicle message broadcasting method in accordance with an embodiment.

Referring to FIG. 3, in operation 310, the processor 220 generates an SM. The SM is, for example, a message about a driving state of a vehicle. For example, the processor 220 may generate the SM based on a society of automotive engineers (SAE) J2735 message standard.

As only examples, the SM may include at least one of a message identifier (ID), a message count, a temporary ID, time, a latitude, a longitude, an elevation, a position accuracy, a transmission, a speed, a heading direction, a steering wheel angle, an acceleration, a break system status, and a vehicle size, in association with a vehicle. As only further examples, the SM may include at least one of an event flag, a path history, a path prediction, and a Radio Technical Commission for Maritime Services (RTCM) package.

For example, when an event occurs in a vehicle, an event flag may be included in the SM. Events may include, for example, sudden breaking of a vehicle, sudden breaking of a neighboring vehicle and/or a loss of control of the vehicle.

In operation 320, the processor 220 determines whether a transmission power of a first wireless communication scheme is to be adjusted. For example, a maximum value of the transmission power may be set for the first wireless communication scheme. The first wireless communication scheme may be for example, a DSRC scheme based on the IEEE 802.11p standard.

When a sufficient communication capacity is provided by the first wireless communication scheme, the transmission power of the first wireless communication scheme is not adjusted. When the communication capacity is not sufficient, the transmission power is adjusted. When, for example, the transmission power is reduced, a coverage area of the first wireless communication scheme may decrease. When the coverage area of the first wireless communication scheme decreases, a number of vehicles located in the coverage of the first wireless communication scheme may decrease, which may lead to an increase in the communication capacity of the first wireless communication scheme.

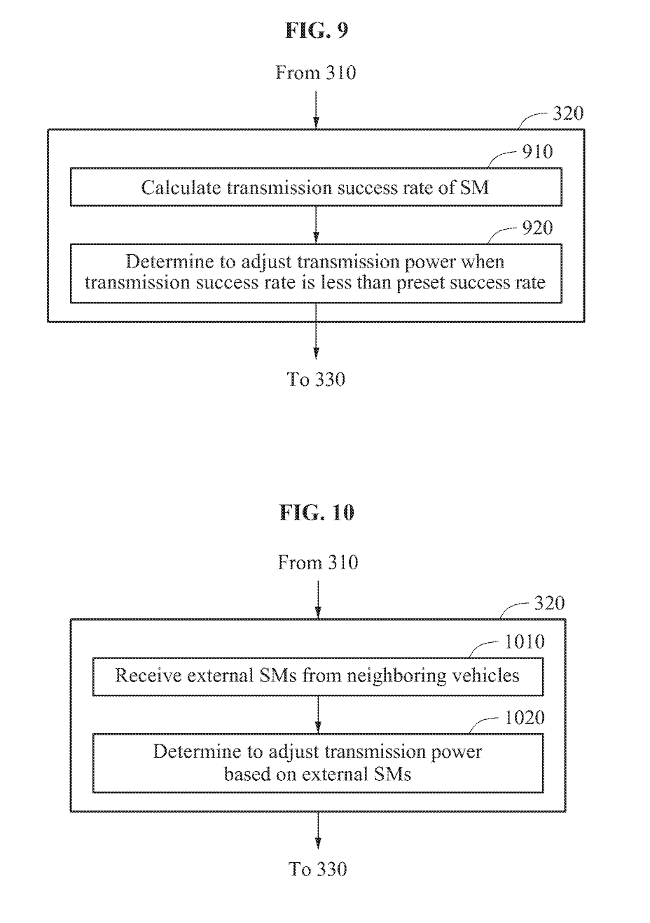

When a certain condition occurs, the processor 220 may adjust the transmission power. Such a condition will be further described below with reference to FIGS. 9 through 11, for example.

In operation 330, the processor 220 adjusts the transmission power of the first wireless communication scheme. The adjusted transmission power may be less than the original transmission power. For example, the processor 220 may adjust the transmission power to have a value between a minimum transmission power Pₘᵢₙ and a maximum transmission power Pₘₐₓ. The minimum transmission power may be a transmission power prescribed to be used in a frequency channel of the first wireless communication scheme.

In an example, the minimum transmission power may be determined based on a location of the vehicle 110 and a minimum signal arrival distance of the first wireless communication scheme. The minimum transmission power may be calculated using the below Equation 1, for example.

Minimum transmission power(Pₘᵢₙ)=f₁(Minimum signal arrival distance, Location of vehicle) Equation 1:

In Equation 1, f₁(x1,x2) denotes a, example function to calculate the minimum transmission power. The minimum signal arrival distance is a minimum distance that allows messages to be exchanged between vehicles when an event does not occur, and may change based on the first wireless communication scheme. A distance travelled by an arriving signal in the first wireless communication scheme may change based on a geographical location and conditions surrounding the vehicle 110. Accordingly, the location of the vehicle 110 may be used to calculate the minimum transmission power.

The storage 230 may store a table used to calculate the minimum transmission power based on the location of the vehicle 110. The processor 220 may calculate, in real time, the minimum transmission power based on a moving route of the vehicle 110, using the table.

In another example, the minimum transmission power may be calculated based on the minimum signal arrival distance. The minimum transmission power may be calculated using the below Equation 2, for example.

Minimum transmission power(Pₘᵢₙ)=f₂(Minimum signal arrival distance) Equation 2:

In Equation 2, f₂(x) denotes a function to calculate the minimum transmission power.

In operation 340, the communicator 210 broadcasts the SM in a vicinity of the vehicle using the first wireless communication scheme. For example, a DSRC or WAVE communication scheme may use a 5 gigahertz (GHz) band, and a used frequency channel of the first wireless communication scheme may have a bandwidth of 10 megahertz (MHz). In the United States, seven channels are allocated to a 5 GHz band, and in the Europe, three channels are allocated. One of the allocated channels may be used to broadcast the SM. The communicator 210 may broadcast the SM within a first temporal period.

In operation 350, the communicator 210 broadcasts an additional message using a second wireless communication scheme.

In an example, the additional message may be the same as the SM. In other words, the additional message is a message transferred to cover a region to which the SM is not transferred using the first wireless communication scheme.

In another example, when an event occurs with reference to the vehicle transmitting the SM, an event flag may be included in the additional message. As described above, the event may include, for example, sudden breaking and/or a loss of control. The additional message may be referred to as, for example, an event message (EM). The EM may include location information about the location in which an event occurs. For example, when an event occurs in a vehicle, location information of the vehicle may be included in the additional message. Throughout the specification, although the term “additional message” is used, the additional message may include one or more separate additional messages. For example, additional messages may contain the same or different data or information.

The second wireless communication scheme may differ from the first wireless communication scheme, and may have a coverage wider than a coverage of the first wireless communication scheme. For example, the first wireless communication scheme may be a DSRC scheme based on the IEEE 802.11p standard, and the second wireless communication scheme may be a cellular communication scheme. That is, the communicator 210 may transmit an additional message to a base station that uses the cellular communication scheme, and the additional message may be broadcast to neighboring vehicles using the cellular communication scheme.

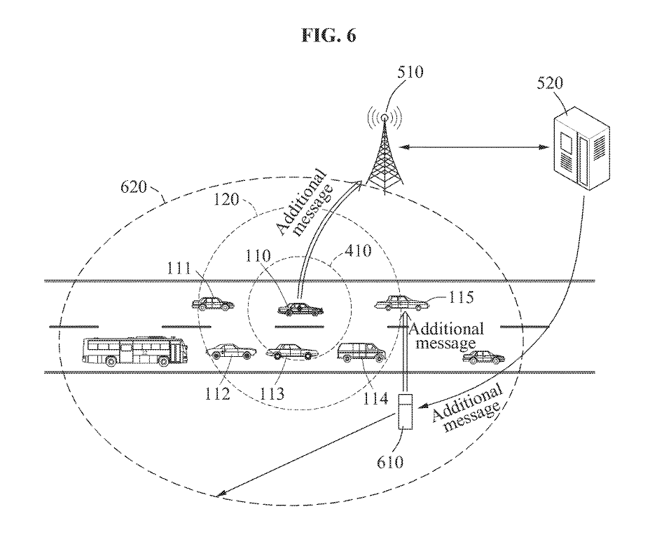

A method of broadcasting an additional message using a cellular communication scheme is further described with reference to FIGS. 5 and 6 below.

The first wireless communication scheme and the second wireless communication scheme may be, for example, DSRC schemes based on the IEEE 802.11p standard, and a frequency channel of the first wireless communication scheme may be different from a frequency channel of the second wireless communication scheme. The frequency channel of the first wireless communication scheme may be a channel with an adjusted transmission power, and the frequency channel of the second wireless communication scheme is a channel with the maximum transmission power. For example, the frequency channel of the second wireless communication scheme may be referred to as an EM channel.

A second temporal period during which the additional message is broadcast may be shorter than the first period during which the SM is broadcast. In other words, as a transmission power used to transmit a message increases, a period during which the message is transmitted may decrease. The communicator 210 may adjust a point in time at which the additional message is broadcast to be identical to a point in time at which an SM is generated and broadcasted using the first communication scheme or they may be broadcast in any order.

The communicator 210 may include a radio configured to simultaneously transmit and receive at least one channel. The communicator 210 may use the radio to broadcast the SM and the additional message and/or to receive an SM and an additional message broadcast from another vehicle.

Operation 360 is performed when the transmission power is determined not to be adjusted in operation 320.

In operation 360, the communicator 210 broadcasts the SM using the first wireless communication scheme in which the transmission power is not adjusted. A coverage of the first wireless communication scheme in which the SM is broadcast may be, for example, a full coverage scheme.

The additional message may be broadcast using the second wireless communication scheme in response to the transmission power of the first wireless communication scheme being adjusted in operations 310 through 350. However, a scheme of broadcasting the additional message is not limited thereto. Accordingly, when the transmission power is not adjusted, the additional message, together with the SM, may be broadcast according to the first wireless communication scheme.

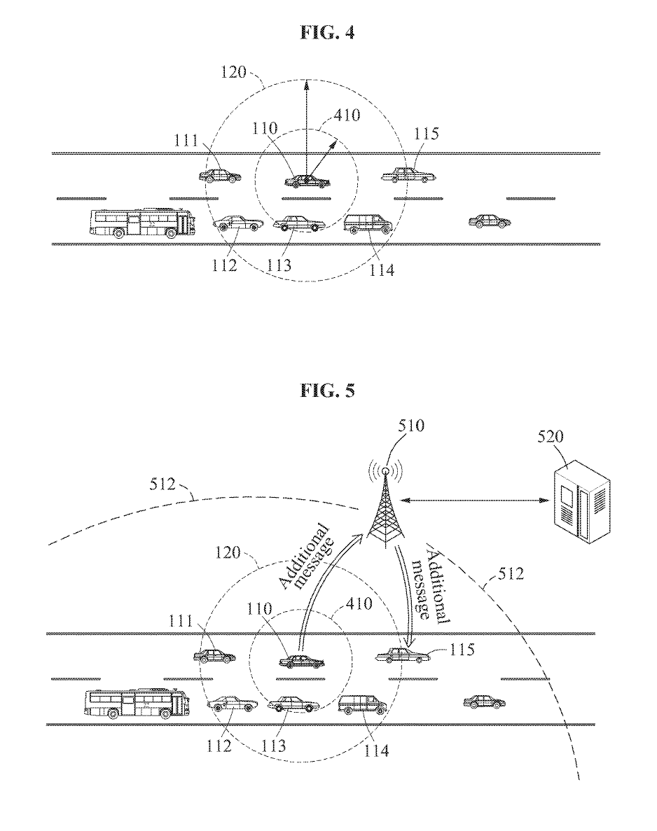

FIG. 4 illustrates coverage of a wireless communication scheme of which a transmission power is adjusted in accordance with an embodiment.

In FIG. 4, a range 120 is a coverage of a first wireless communication scheme of which a transmission power is not adjusted. Vehicles 111 through 115 are located in the range 120. When the transmission power of the first wireless communication scheme is not adjusted, an SM is broadcast to the vehicles 111 through 115.

When the transmission power of the first wireless communication scheme is adjusted, the coverage of the first wireless communication scheme decreases. As shown in FIG. 4, the vehicle 113 is located in a reduced coverage 410, and may be SM of the vehicle 110 may be able to broadcast to the vehicle 113. When the coverage of the first wireless communication scheme decreases, a communication capacity of the first wireless communication scheme increases. Due to an increase in the communication capacity, the SM of the vehicle 110 may be broadcast to the vehicle 113 in real time without a delay.

The vehicles 111, 112, 114 and 115 are located outside the coverage 410 due to adjustment of the transmission power. To provide the SM to the vehicles 111, 112, 114 and 115, a second wireless communication scheme is used. A coverage of the second wireless communication scheme is wider than the coverage 410. A coverage of the second wireless communication scheme is further described with reference to FIGS. 5 and 6 below.

FIG. 5 illustrates a broadcasting of an additional message in accordance with an embodiment.

In an example, the communicator 210 transmits an additional message to a base station 510 using a second wireless communication scheme. In this example, the base station 510 uses a cellular communication scheme to cover a location of a vehicle 110.

In another example, the communicator 210 may transmit the additional message to a road side unit (RSU) using the second wireless communication scheme. The RSU may support a cellular communication scheme and may be located near the road the communicator 210 is on. The RSU may include a radio configured to simultaneously transmit and receive at least one channel. The RSU may receive an SM and an additional message transmitted by any of the vehicles using the radio. A vehicle and the RSU may communicate with each other using, for example, a vehicle-to-infrastructure (V2I) communication technology.

In an embodiment, the base station 510 or the RSU exchange data with an EM server 520. The base station 510 and the EM server 520 may be connected to each other via a backbone. The base station 510 may transmit the additional message to the EM server 520. The EM server 520 may analyze the additional message and determine the location of the vehicle 110. The EM server 520 may determine a base station or an RSU that covers the location of the vehicle 110. The above-described base station 510 covers the location of the vehicle 110, however, there is no limitation thereto. For example, when the location of the vehicle 110 changes, base stations other than the base station 510 may cover the location of the vehicle 110, so those other base stations or RSUs may be alerted or vehicle 110 maybe instructed of the other base stations or RSUs.

The base station 510 broadcasts the additional message to neighboring vehicles 111 through 115 located adjacent to the vehicle 110. A coverage 512 of the base station 510 includes a coverage 120 of the first wireless communication scheme of which a transmission power is not adjusted. Because the coverage 512 is wider than the coverage 120, the additional message is broadcast to the vehicles 111, 112, 114 and 115 that fail to receive the SM due to adjustment of the transmission power.

FIG. 6 illustrates a broadcasting of an additional message in accordance with an embodiment.

The EM server 520 of FIG. 5 may determine the location of the vehicle 110 based on data contained in the additional message, and may determine an RSU 610 corresponding to the location of the vehicle 110 among RSUs. The RSU 610 may then be instructed to broadcast the additional message. The RSU 610 is located on a side of a road as shown in FIG. 6, however, a location of the RSU 610 is not limited thereto. For example, the RSU 610 may be located above the road.

The RSU 610 may broadcast the additional message using a DSRC scheme based on the IEEE 802.11p standard, for example. A frequency channel of the RSU 610 may be different from a frequency channel of the first wireless communication scheme. For example, the frequency channel of the RSU 610 may be the same as a frequency channel of the second wireless communication scheme.

A coverage 620 of the RSU 610 includes a coverage 120 of the first wireless communication scheme of which a transmission power is not adjusted. Because the coverage 620 is wider than the coverage 120, the additional message may be broadcast to the vehicles 111, 112, 114 and 115 that fail to receive the SM due to adjustment of the transmission power.

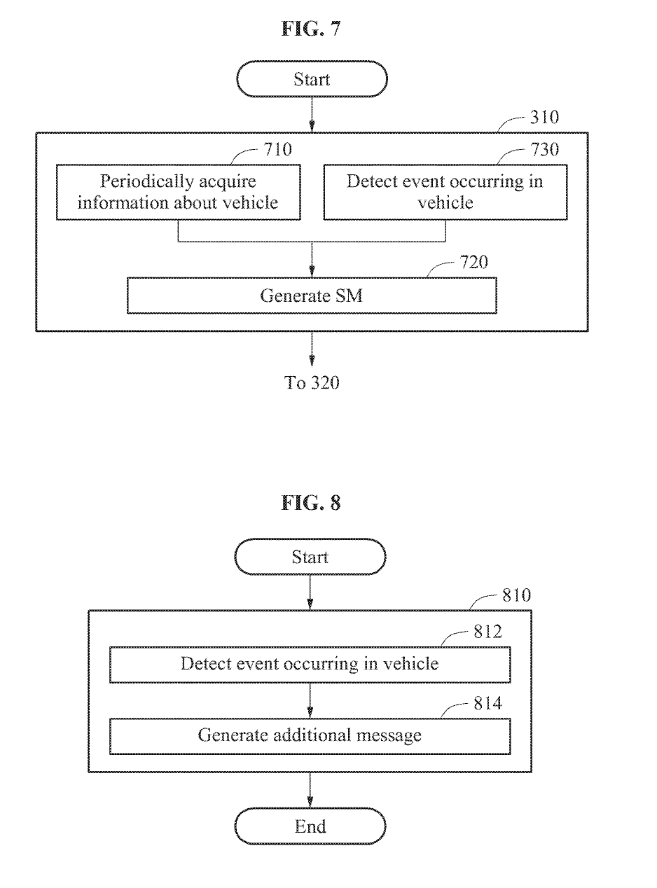

FIG. 7 illustrates a generating of an SM in a vehicle message broadcasting method in accordance with an embodiment.

In this example, this operation 310 may include operations 710, 720 and 730.

Referring to FIG. 7, in operation 710, the processor 220 periodically acquires information about the vehicle 110.

In operation 720, the processor 220 generates an SM based on the acquired information about the vehicle 110. The processor 220 may change a period of generation of an SM based on a type of the first wireless communication scheme. As only an example, when the first wireless communication scheme is a DSRC scheme, the processor 220 may generate an SM ten times per second while the SM may generate less or more times per second in other schemes.

Operation 730 is performed in parallel with operation 710. When an event occurs in a vehicle, the processor 220 detects the event in operation 730. When the event is detected, the processor 220 generates an SM by including information about the event in the SM.

FIG. 8 illustrates a generating of an additional message in accordance with an embodiment.

The vehicle message broadcasting method of FIG. 3 further includes operation 810, and operation 810 includes operations 812 and 814. For example, operation 810 may be performed prior to operation 350.

Referring to FIG. 8, when an event occurs relating to a vehicle, the processor 220 detects the event in operation 812.

In operation 814, the processor 220 generates an additional message including information about the detected event. The additional message also includes information included in the SM broadcast using the first communication scheme.

FIG. 9 illustrates a determining of whether a transmission power is to be adjusted in a vehicle message broadcasting method in accordance with an embodiment.

Operation 320 includes operations 910 and 920.

The vehicle 110 and neighboring vehicles of the vehicle 110 may use the same frequency channel to transmit or broadcast the SM. When a large number of neighboring vehicles are located adjacent to the vehicle 110, the vehicle 110 may compete with the neighboring vehicles to use the frequency channel. When the frequency channel is not acquired, the vehicle 110 may fail to transmit the SM.

Referring to FIG. 9, in operation 910, the processor 220 calculates a transmission success rate of the SM transmitted using the first wireless communication scheme.

In operation 920, the processor 220 determines whether to adjust the transmission power of the first wireless communication scheme based on the transmission success rate being less than a threshold success rate. The transmission power may be calculated based on the transmission success rate. For example, the transmission power may be calculated using the below Equation 3, for example.

Transmission power=f₃(Transmission success rate) Equation 3:

In Equation 3, f₃(x) denotes a function to calculate the transmission power. The transmission power may be calculated in a range of a minimum transmission power to a maximum transmission power. The transmission power may be calculated, for example, in proportion to a value of the transmission success rate. Thus, when the transmission success rate has a higher value, the calculated transmission power may be a higher transmission power when the transmission success rate has a lower value.

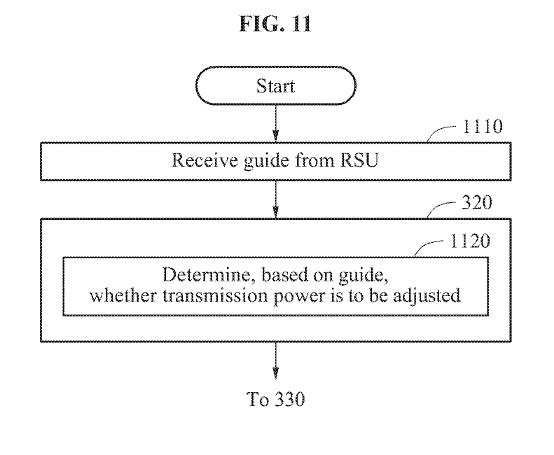

FIG. 10 illustrates determining whether a transmission power is to be adjusted in a vehicle message broadcasting method in accordance with an embodiment.

Operation 320 includes operations 1010 and 1020.

Referring to FIG. 10, in operation 1010, the communicator 210 receives external SMs from neighboring vehicles. The external SMs are broadcast from the neighboring vehicles.

In operation 1020, the processor 220 determines whether to adjust the transmission power of the first wireless communication scheme based on a determined or observed property of the received external SMs. For example, when a number of neighboring vehicles identified by a plurality of external SMs is equal to or greater than a preset threshold, the processor 220 may determine to adjust the transmission power of the first wireless communication scheme.

FIG. 11 illustrates determining whether a transmission power is to be adjusted in a vehicle message broadcasting method in accordance with an embodiment.

Operation 1110 is performed prior to operation 320. In operation 1110, the communicator 210 receives a guide from an RSU. The guide may include information about the transmission power of the first wireless communication scheme.

For example, the EM server 520 of FIG. 5 may acquire information about road and traffic conditions from RSUs, and determine the transmission power of the first wireless communication scheme based on the acquired information. The EM server 520 may transmit a guide to an RSU, and the RSU may broadcast the guide. For example, the RSU may use a DSRC scheme to broadcast the guide.

Operation 320 includes operation 1120. In operation 1120, the processor 220 determines, based on the guide, whether the transmission power of the first wireless communication scheme is to be adjusted. For example, when a transmission power of the guide is less than a threshold transmission power, the processor 220 may adjust the transmission power of the first wireless communication scheme to the transmission power prescribed by the guide.

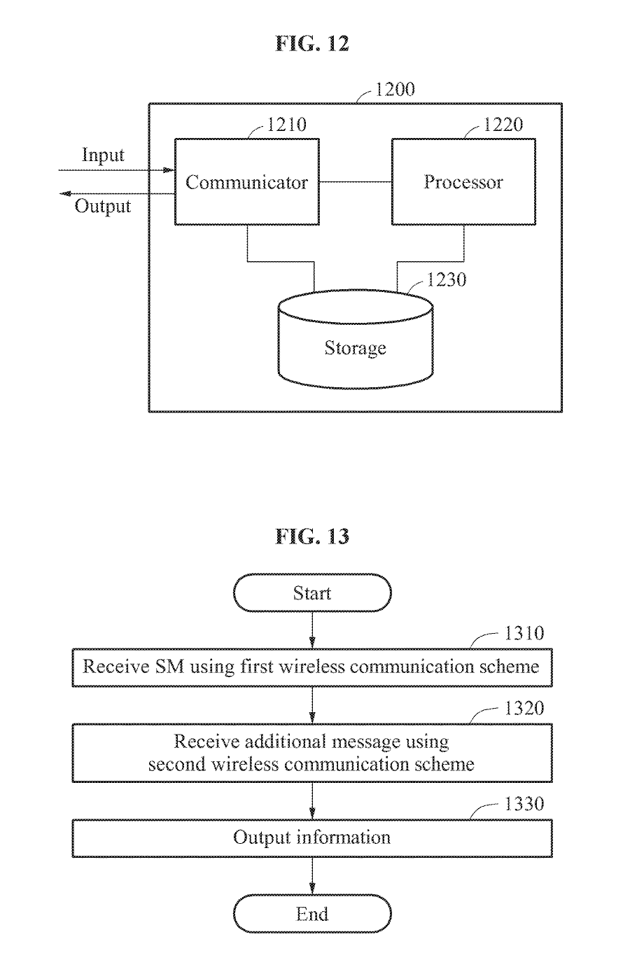

FIG. 12 illustrates a configuration of a vehicle message receiving apparatus 1200 in accordance with an embodiment.

Referring to FIG. 12, the vehicle message receiving apparatus 1200 (hereinafter, referred to as the “apparatus 1200”) includes a communicator 1210, a processor 1220 and a storage 1230.

The apparatus 1200 may be installed in, for example, the vehicle 110 of FIG. 1. For example, the apparatus 200 of FIG. 2 and the apparatus 1200 may be installed in the same vehicle 110, and may include similar features. That is, the communicator 1210, the processor 1220, and the storage 1230 may have similar features as the communicator 210, the processor 220, and the storage 230 in the apparatus 200, respectively.

Hereinafter, the communicator 1210, the processor 1220, and the storage 1230 are further described with reference to FIG. 13.

FIG. 13 illustrates a vehicle message receiving method in accordance with an embodiment.

Referring to FIG. 13, in operation 1310, the communicator 1210 receives an SM including data/information about a neighboring vehicle from the neighboring vehicle using a first wireless communication scheme. The neighboring vehicle reduces a transmission power of the first wireless communication scheme and broadcasts the SM.

In operation 1320, the communicator 1210 receives an additional message using a second wireless communication scheme. In an example, the communicator 1210 may receive the additional message from a base station using a cellular communication scheme. In another example, the communicator 1210 may receive the additional message from an RSU. The RSU may cover or have a coverage of the neighboring vehicle that may be reduced by adjusting the transmission power of the first wireless communication scheme.

In operation 1330, the processor 1220 outputs data/information included in at least one of the received SM and the received additional message. In an embodiment, information regarding both an SM and the additional message may be exemplary, and may be combined as necessary. For example, the processor 1220 may output the information as sounds using speakers, or visually outputs the information using a display. Additionally or alternatively, in an advanced driver assistance system (ADAS) or an autonomous vehicle, the information may be utilized to control a vehicle.

The apparatuses, units, modules, devices, and other components illustrated in FIGS. 2 and 12 that perform the operations described herein with respect to FIGS. 3, 7, 8, 9, 10, 11 and 13 are hardware components. Examples of hardware components include controllers, sensors, generators, drivers, and any other electronic components known to one of ordinary skill in the art after having a full understanding of the present specification. In one example, the hardware components are one or more processing devices, such as one or more processors or computers. A processor or computer is implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices known to one of ordinary skill in the art after having a full understanding of the present specification that is capable of responding to and executing instructions in a defined manner to achieve a desired result. In one example, a processor or computer includes, or is connected to, one or more memories storing instructions or software that are executed by the processor or computer. Hardware components implemented by a processor or computer execute instructions or software, such as an operating system (OS) and one or more software applications that run on the OS, to perform the operations described herein with respect to FIGS. 3, 7, 8, 9, 10, 11 and 13. The hardware components also access, manipulate, process, create, and store data in response to execution of the instructions or software. For simplicity, the singular term “processor” or “computer” may be used in the description of the examples described herein, but in other examples multiple processors or computers are used, or a processor or computer includes multiple processing elements, or multiple types of processing elements, or both. In one example, a hardware component includes multiple processors, and in another example, a hardware component includes a processor and a controller. A hardware component has any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

Instructions or software to control a processor or computer to implement the hardware components and perform the methods as described above are written as computer programs, code segments, instructions or any combination thereof, for individually or collectively instructing or configuring the processor or computer to operate as a machine or special-purpose computer to perform the operations performed by the hardware components and the methods as described above. In one example, the instructions or software include machine code that is directly executed by the processor or computer, such as machine code produced by a compiler. In another example, the instructions or software include higher-level code that is executed by the processor or computer using an interpreter. Programmers of ordinary skill in the art, after having a full understanding of the present specification, can readily write the instructions or software based on the block diagrams and the flow charts illustrated in the drawings and the corresponding descriptions in the specification, which disclose algorithms for performing the operations performed by the hardware components and the methods as described above.

The instructions or software to control a processor or computer to implement the hardware components and perform the methods as described above, and any associated data, data files, and data structures, are recorded, stored, or fixed in or on one or more non-transitory computer-readable storage media. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, and any device known to one of ordinary skill in the art after having a full understanding of the present specification that is capable of storing the instructions or software and any associated data, data files, and data structures in a non-transitory manner and providing the instructions or software and any associated data, data files, and data structures to a processor or computer so that the processor or computer can execute the instructions. In one example, the instructions or software and any associated data, data files, and data structures are distributed over network-coupled computer systems so that the instructions and software and any associated data, data files, and data structures are stored, accessed, and executed in a distributed fashion by the processor or computer.

While this disclosure includes specific examples, it will be apparent to one of ordinary skill in the art, after having a full understanding of the present specification, that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A vehicle message broadcasting method, comprising:
determining whether a transmission power set for broadcasting a message by a communication device using a first wireless communication scheme is to be adjusted, the first wireless communication scheme being used to transmit a safety message (SM);
broadcasting a safety message (SM) using the first wireless communication scheme with a transmission power based on a result of the determining; and
broadcasting at least one additional message including information included in the SM and/or information related to the SM using a second wireless communication scheme having a wider coverage than a coverage of the first wireless communication scheme.

2. The vehicle message broadcasting method of claim 1, wherein the first wireless communication scheme is a dedicated short-range communications (DSRC) scheme based on an Institute of Electrical and Electronics Engineers (IEEE) 802.11p standard.

3. The vehicle message broadcasting method of claim 1, wherein the first wireless communication scheme is a wireless communication scheme based on an IEEE 802.11p standard, and
wherein the second wireless communication scheme is a cellular communication scheme.

4. The vehicle message broadcasting method of claim 1, wherein the first wireless communication scheme and the second wireless communication scheme are wireless communication schemes based on an IEEE 802.11p standard, and
wherein a frequency channel of the first wireless communication scheme is different than a frequency channel of the second wireless communication scheme.

5. The vehicle message broadcasting method of claim 1, wherein the at least one additional messages include an additional message that includes same information as information included in as the SM.

6. The vehicle message broadcasting method of claim 1, wherein the at least one additional message include an event message (EM) generated in response to an event related to a vehicle and related to the SM.

7. The vehicle message broadcasting method of claim 6, wherein the EM comprises location information corresponding to a location of the event.

8. The vehicle message broadcasting method of claim 1, further comprising generating the SM,
wherein the generating of the SM comprises:
acquiring information related to a vehicle; and
generating the SM based on the information related to the vehicle.

9. The vehicle message broadcasting method of claim 8, wherein the generating of the SM further comprises:
detecting an event related to the vehicle; and
further including information about the event to the SM and generating the SM in response to the event being detected.

10. The vehicle message broadcasting method of claim 1, further comprising generating the additional message,
wherein the generating of the additional message comprises:
detecting an event occurring in the vehicle; and
generating the additional message based on the detected event.

11. The vehicle message broadcasting method of claim 1, wherein the determining of whether the transmission power is to be adjusted comprises:
calculating a transmission success rate of the SM transmitted using the first wireless communication scheme; and
determining to adjust the transmission power lower in response to the transmission success rate being determined to be less than a threshold success rate.

12. The vehicle message broadcasting method of claim 1, wherein the determining of whether the transmission power is to be adjusted comprises determining to adjust the transmission power based on determined properties of at least one externally received SM.

13. The vehicle message broadcasting method of claim 12, wherein the determining to adjust the transmission power based on the at least one external SM comprises, in response to a number of the neighboring vehicles identified by the plurality of external SMs is determined to be equal to or greater than a preset threshold, determining to adjust the transmission power lower.

14. The vehicle message broadcasting method of claim 1, further comprising receiving a guide from a road side unit (RSU),
wherein the determining of whether the transmission power is to be adjusted comprises determining, based on the guide, whether the transmission power is to be adjusted.

15. A vehicle message broadcasting apparatus, comprising:
a processor configured to determine whether a transmission power of a first wireless communication scheme is to be adjusted, the first wireless communication scheme being used to transmit a safety message (SM); and
a communicator configured to broadcast the SM using the first wireless communication scheme with the adjusted transmission power and to broadcast at least one additional message using a second wireless communication scheme.

16. A vehicle message receiving method, comprising:
receiving a safety message (SM) comprising information related to a vehicle using a first wireless communication scheme;
receiving an additional message including information included in or related to the SM using a second wireless communication scheme having a different property from the first wireless communication scheme; and
outputting information included in at least one of the SM and the additional message.

17. The vehicle message receiving method of claim 16, wherein the first wireless communication scheme is a dedicated short-range communications (DSRC) scheme based on an Institute of Electrical and Electronics Engineers (IEEE) 802.11p standard.

18. The vehicle message receiving method of claim 16, wherein the first wireless communication scheme is a wireless communication scheme based on an IEEE 802.11p standard, and
wherein the second wireless communication scheme is a cellular communication scheme.

19. The vehicle message receiving method of claim 16, wherein the first wireless communication scheme and the second wireless communication scheme are wireless communication schemes based on an IEEE 802.11p standard, and
wherein a frequency channel of the first wireless communication scheme is different from a frequency channel of the second wireless communication scheme.

20. The vehicle message receiving method of claim 16, wherein the receiving of the additional message comprises receiving the additional message from a road side unit (RSU).

21. The vehicle message receiving method of claim 20, wherein the RSU broadcasts the additional message based on location information of an event, and the location information of the event is included in the additional message.

22. A vehicle message receiving apparatus, comprising:
a communicator configured to receive a safety message (SM) using a first wireless communication scheme and to receive an additional message using a second wireless communication scheme with a different property than a first wireless communication scheme; and
a processor configured to output information included in at least one of the SM and the additional message.
